(19) United States
(12) Patent Application Publication
(10) Pub. No.: US 2020/0328691 A1
(43) Pub. Date: Oct. 15, 2020

(54) DC BUS CAPACITOR BALANCING FOR THREE-LEVEL, SIX-PHASE VOLTAGE SOURCE CONVERTERS

(71) Applicant: Hamilton Sundstrand Corporation, Charlotte, NC (US)

(72) Inventors: Lei Xing, South Windsor, CT (US); Xin Wu, Glastonbury, CT (US)

(21) Appl. No.: 16/381,366

(22) Filed: Apr. 11, 2019

(51) Int. Cl. H02M 5/458; H02J 7/00

(52) U.S. Cl. CPC H02M 5/458; H02J 7/345; H02J 7/0014

(57) ABSTRACT

Provided are embodiments including a system for balancing DC bus capacitors for converters. The system can include a first 3-phase system, and a second 3-phase system, wherein the first 3-phase system and the second 3-phase system are operably connected. The system can also include one or more DC capacitors coupled to the first 3-phase system and the second 3-phase system, and a controller, wherein the controller is configured to control switching of the first 3-phase system and the second 3-phase system so that an output of second 3-phase system is delayed 60 degrees from an output of the first 3-phase system. Also, embodiments are provided for a method for balancing DC bus capacitors.

### BACKGROUND

The subject matter disclosed herein relates generally to power systems, and, more particularly, to direct current (DC) bus capacitor balancing for three-level, six-phase voltage source converters.

Converters are employed in a variety of applications to convert direct current (DC) power to alternating current (AC) power and vice versa. A converter for DC-to-AC conversion is referred to as an inverter, while an AC-to-DC converter is referred to as a rectifier. Employing active components, such as transistors, allows for regulation of the voltages generated by the converter. Multi-level converters are used in a wide variety of power applications. For example, converters are used in power supplies and variable speed drives. Three-level converters are often selected for their improved AC current waveform and high power density.

### BRIEF DESCRIPTION

According to an embodiment, a system for balancing DC bus capacitors for converters is provided. The system includes a first 3-phase system, a second 3-phase system, wherein the first 3-phase system and the second 3-phase system are operably connected, one or more DC capacitors coupled to the first 3-phase system and the second 3-phase system, and a controller, wherein the controller is configured to control switching of the first 3-phase system and the second 3-phase system so that an output of second 3-phase system is delayed 60 degrees from an output of the first 3-phase system.

In addition to one or more of the features described herein, or as an alternative, further embodiments include a first 3-phase system and a second 3-phase system that operate as a 6-phase converter.

In addition to one or more of the features described herein, or as an alternative, further embodiments include one or more DC capacitors that are coupled to a floating midpoint.

In addition to one or more of the features described herein, or as an alternative, further embodiments include one or more DC capacitors that are coupled to a grounded midpoint.

In addition to one or more of the features described herein, or as an alternative, further embodiments include a voltage across the one or more DC capacitors that are charged and discharged to an equal magnitude during operation.

In addition to one or more of the features described herein, or as an alternative, further embodiments include a midpoint current from the midpoint of one or more DC capacitors that are equal.

In addition to one or more of the features described herein, or as an alternative, further embodiments include a filter for each phase of the first 3-phase system and the second 3-phase system.

In addition to one or more of the features described herein, or as an alternative, further embodiments include one or more DC capacitors charging cycle and discharge cycle are controlled by the controller.

According to an embodiment, a method for balancing DC bus capacitors for converters is provided. The method includes operating a first 3-phase system, operating a second 3-phase system, wherein the first 3-phase system and the second 3-phase system are operably connected, charging and discharging one or more DC capacitors coupled to the first 3-phase system and the second 3-phase system, and balancing charging and discharging of the one or more DC capacitors by controlling switching of the first 3-phase system and the second 3-phase system so that an output of second 3-phase system is delayed 60 degrees from an output of the first 3-phase system.

In addition to one or more of the features described herein, or as an alternative, further embodiments include operating the first 3-phase system and the second 3-phase system as a 6-phase converter.

In addition to one or more of the features described herein, or as an alternative, further embodiments include one or more DC capacitors that are coupled to a floating midpoint.

In addition to one or more of the features described herein, or as an alternative, further embodiments include one or more DC capacitors that are coupled to a grounded midpoint.

In addition to one or more of the features described herein, or as an alternative, further embodiments include charging and discharging the one or more DC capacitors to a voltage equal magnitude during operation.

In addition to one or more of the features described herein, or as an alternative, further embodiments include a midpoint current from the midpoint of the one or more DC capacitors that are equal.

In addition to one or more of the features described herein, or as an alternative, further embodiments include filtering each phase of the first 3-phase system and the second 3-phase system.

In addition to one or more of the features described herein, or as an alternative, further embodiments include controlling a charging cycle and discharge cycle of the one or more DC capacitors.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 depicts a block diagram of a system including a three-level, 6-phase converter in accordance with one or more embodiments;

FIG. 2 depicts a single phase leg of the 3-phase system having a grounded midpoint is shown;

FIG. 3 depicts a waveform representing the overall current measured for a single phase system;

FIG. 4 depicts a waveform illustrating a voltage plot for each phase of the 6-phase system in accordance with one or more embodiments;

FIG. 5 depicts a waveform that combines the overall current represented by the first 3-phase system and the second 3-phase system in accordance with one or more embodiments; and

FIG. 6 depicts a flowchart of a method for balancing a DC capacitor for a three-level, 6-phase system in accordance with one or more embodiments.

### DETAILED DESCRIPTION

DC bus capacitors are used to couple the output of three-level converters to a DC bus. However, oftentimes distortion occurs at the output which may require filtering. Unbalanced DC bus capacitors can also be a source for a distorted output as the mid-point current which charges and discharges the two capacitors are discharging at different levels. Without any balancing control, the mid-point voltage will fluctuate causing a distorted output current. One type of conventional balancing scheme includes injecting a common mode voltage to the output voltage. However, this can increase the output common mode noise and further increase the converter weight. Other conventional methods can induce more switching, which may increase switching loss by 30% to 60% which can be a burden to the cooling system.

It is important the output has minimal distortion so that the connected devices, equipment, and systems can use the generated power without causing any damage. For example, the unbalanced capacitors can lead to increased voltage and current stress of the DC capacitors, increased losses in the capacitors, and reduced life of the capacitors. The techniques described herein provide for DC capacitor balancing to improve the output performance of the three-level, six-phase converters.

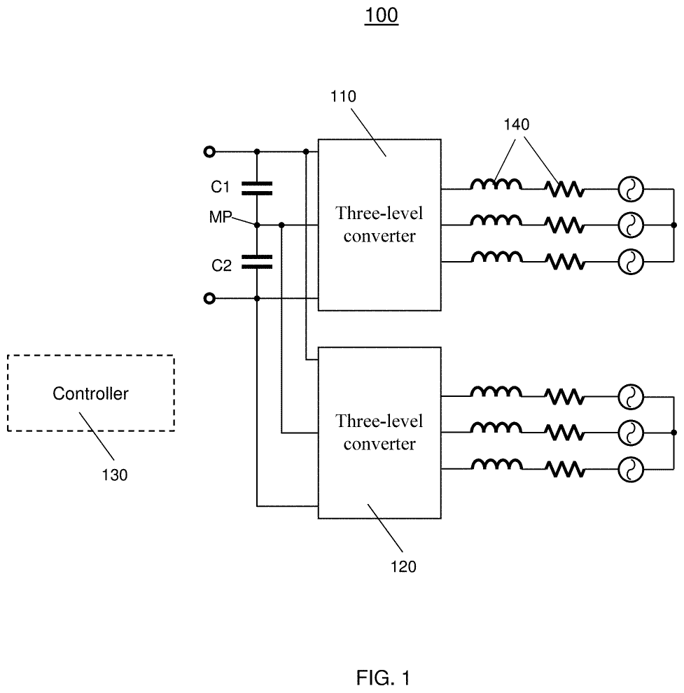

FIG. 1 depicts a block diagram of a system 100 including a first three-level converter 110 and a second three-level converter 120 in accordance with one or more embodiments. As shown in FIG. 1, a first capacitor C1 is coupled to a first power supply rail and a middle point (MP), and a second capacitor C2 is coupled to a second power supply rail and the MP. The output of each of the three-level converters 110, 120 includes components 140 to filter the signal such as inductors, resistors, and/or capacitors.

The switches (not shown) included in each three-level converter 110 and 120 can include any type of switch and any configuration that is under the control of the controller 130. For example, the switches can include semiconductor switches such as MOSFETs or other transistors such as insulated-gate bipolar transistors (IGBT).

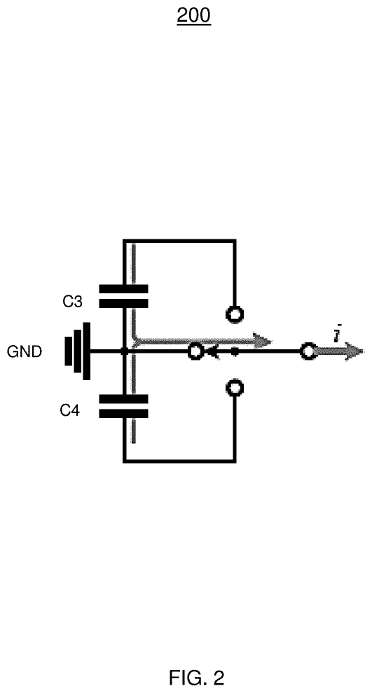

Now referring to FIG. 2, a single phase leg of a convention 3-phase system is shown. The current i is shown where the midpoint is grounded. The midpoint current is produced as the capacitors C3 and C4 are charged and discharged. The unbalanced charging and discharging can lead to distortion at the output of the system.

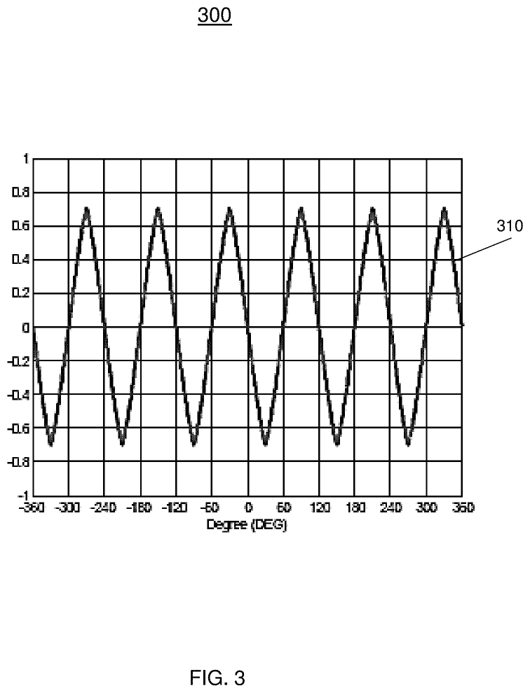

FIG. 3 illustrates a waveform for a 3-phase system. The overall mid-point in two cycles is shown from −360 degrees to 360 degrees. The current i fluctuates between 0.7 and −0.7 amps over the range which can lead to an imbalance in the DC capacitors. There is no control shown for the mid-point current.

The techniques described herein balance the DC capacitors for a 6-phase system 100 by inserting a 60 degree phase shift between the two sets of three-phase systems. The phase shift can make sure the mid-point currents provided by each set of the three-phase system cancel each other out. Consider the following Equations 1, 2, and 3:

$$\begin{matrix}\{ \begin{matrix}{v}_{a 1} = V cos ωt \\ {v}_{b 1} = V cos ( ω t - \frac{2 π}{3} ) \\ {v}_{c 1} = V cos ( ω t + \frac{2 π}{3} ) \\ {v}_{a 2} = V cos ( ω t - \frac{π}{3} ) \\ {v}_{b 2} = V cos ( ω t - \frac{π}{3} - \frac{2 π}{3} ) \\ {v}_{c 2} = V cos ( ω t - \frac{π}{3} + \frac{2 π}{3} )\end{matrix} & ( Eq . 1 ) \\ and & \\ \{ \begin{matrix}{i}_{a 1} = I cos ( ω t - ϕ ) \\ {i}_{b 1} = I cos ( ω t - \frac{2 π}{3} - ϕ ) \\ {i}_{c 1} = I cos ( ω t + \frac{2 π}{3} - ϕ ) \\ {i}_{a 2} = I cos ( ω t - \frac{π}{3} - ϕ ) \\ {i}_{b 2} = I cos ( ω t - \frac{π}{3} - \frac{2 π}{3} - ϕ ) \\ {i}_{c 2} = I cos ( ω t - \frac{π}{3} + \frac{2 π}{3} - ϕ )\end{matrix} & ( Eq . 2 )\end{matrix}$$

where φ is the power factor angle and does not affect the result in this example. The overall mid-point current can be calculated as follows in Equation 3:

i_{mid}=Σ(1−|vₓ|)iₓ, i=a1, b1, c1, a2, b2, c2 (Eq. 3)

According to the Equation 3, the midpoint current imid is approximately zero if the phase shift between a1 and a2 is 60 degrees which is illustrated in FIG. 3. This illustrates that the three-level, 6-phase converter 100 does not have any balancing issues, and it can be applied to a variety of different load cases. There is no addition common mode injector or additional switching that is required.

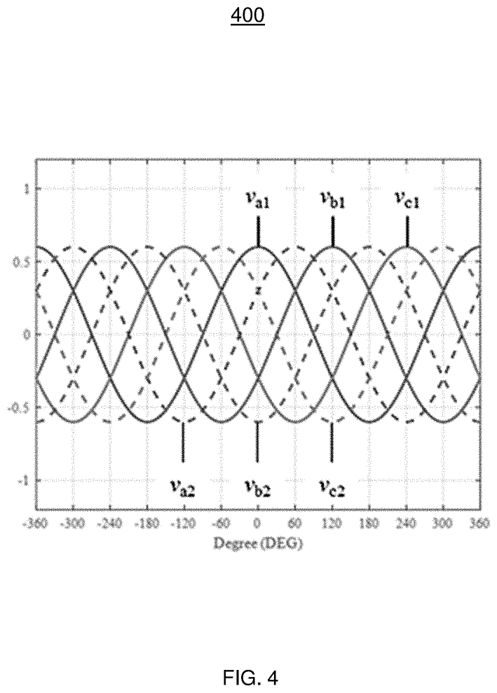

FIG. 4 depicts the waveform 400 for two three-level converters such as that shown in FIG. 1. The two three-level converters are phase-shifted 60 degrees from one another to achieve the reduced distortion. The waveforms associated with a first three-level converter 110 can include waveforms Va1, Vb1, and Vc1 (shown in solid lines), and the waveforms associated with a second three-level converter 120 can include waveforms Va2, Vb2, and Vc2 (shown in dotted lines).

Due to the phase-shift between the first three-phase system and the second three-phase system the overall imbalance between the two systems are canceled. This helps to balance the DC capacitors and additionally reduces the distortion experienced at the output of the system.

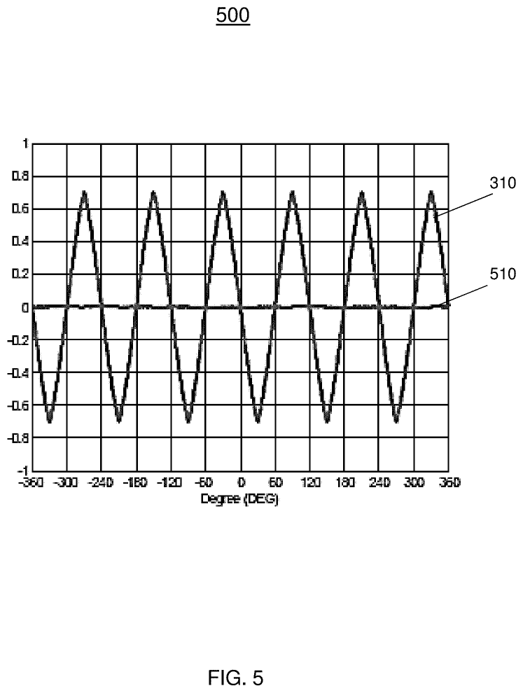

As shown in FIG. 5, the waveform 310 representing the overall waveform for a first single three-phase system and the combined waveform 510 for the first three-phase system and a second three-phase system where the second three-phase system is phase-shifted by 60 degrees by the controller 130 are shown. If a second waveform (not shown) similar to the waveform 310 is overlaid on the graph and is offset by 60 degrees, the resulting waveform 510 would result. The embodiments include a controller configured to controller the switching of the first three-phase system and the second three-phase system to achieve a 60 degree offset which balances the DC capacitors C1 and C2. The controller 130 generates the phase information for the six voltages shown in FIG. 4. The controller 130 is configured to generate 60 degrees between the voltages (Va1, Vb1, and Vc1) of a first system and the voltages (Va2, Vb2 and Vc2) of a second system.

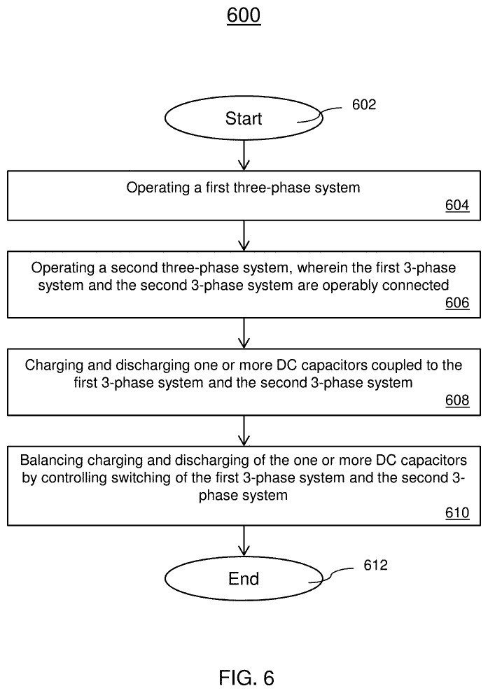

FIG. 6 depicts a flowchart of a method 600 for balancing DC capacitors for a six-phase converter system in accordance with one or more embodiments. The method 600 begins at block 602 and continues to block 604 which includes operating a first 3-phase system. The method 600 at block 606 provides for operating a second 3-phase system, wherein the first 3-phase system and the second 3-phase system are operably connected. In one or more embodiments, a controller controls the switching of switching device within each 3-phase system to generate a controlled AC signal that is to be provided to the system. The two 3-phase systems operate as a 6-phase converter to produce a controlled AC signal. At block 600 the charging and discharging of one or more DC capacitors coupled to the first 3-phase system and the second 3-phase system is controlled, and at block 610 a controller balances the charging and discharging of the one or more DC capacitors by controlling the switching of the first 3-phase system and the second 3-phase system. The balancing is achieved by implementing a 60 degree offset between the first 3-phase system and the second 3-phase system which cancels the noise or distortion produced from each 3-phase system. By canceling the noise and distortion high quality power can be provided to other systems for use. The method 600 ends at block 612.

The technical effects and benefits provide a simplified architecture for balancing the DC link capacitors to remove the distortion from the output power. Therefore, no common mode injector or additional switching other than that required for regular operation is needed.

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A system for balancing DC bus capacitors for converters, the system comprising:
a first 3-phase system, wherein the first 3-phase system is a three-level converter;
a second 3-phase system, wherein the second 3-phase system is a three-level converter, wherein the first 3-phase system and the second 3-phase system are operably connected;
two or more DC capacitors coupled to the first 3-phase system and the second 3-phase system; and
a controller, wherein the controller is configured to control switching of the first 3-phase system and the second 3-phase system so that an output of second 3-phase system is delayed 60 degrees from an output of the first 3-phase system, wherein the first 3-phase system and the second 3-phase system are the only 3-phase systems that are coupled to the controller such that the output of the second 3-phase system is delayed 60 degrees from the output of the first 3-phase system.

2. The system of claim 1, wherein the first 3-phase system and the second 3-phase system operate as a 6-phase converter.

3. (canceled)

4. The system of claim 1, wherein the two or more DC capacitors are coupled to a grounded midpoint.

5. The system of claim 1, wherein a voltage across the two or more DC capacitors are charged and discharged to an equal magnitude during operation.

6. The system of claim 1, wherein a midpoint current from the midpoint of two or more DC capacitors are equal.

7. The system of claim 1, further comprising a filter for each phase of the first 3-phase system and the second 3-phase system.

8. The system of claim 1, wherein the two or more DC capacitors charging cycle and discharge cycle are controlled by the controller.

9. A method for balancing DC bus capacitors for converters, the method comprising:
operating, using a controller, a first 3-phase system, wherein the first 3-phase system is a three-level converter;
operating, using the controller, a second 3-phase system, wherein the first 3-phase system is a three-level converter, wherein the first 3-phase system and the second 3-phase system are operably connected;
charging and discharging one or more DC capacitors coupled to the first 3-phase system and the second 3-phase system; and
balancing charging and discharging of the two or more DC capacitors by controlling switching of the first 3-phase system and the second 3-phase system so that an output of second 3-phase system is delayed 60 degrees from an output of the first 3-phase system, wherein the first 3-phase system and the second 3-phase system are the only 3-phase systems that are coupled to the controller such that the output of the second 3-phase system is delayed 60 degrees from the output of the first 3-phase system.

10. The method of claim 9, further comprising operating the first 3-phase system and the second 3-phase system as a 6-phase converter.

11. (canceled)

12. The method of claim 9, wherein the two or more DC capacitors are coupled to a grounded midpoint.

13. The method of claim 9, further comprising charging and discharging the two or more DC capacitors to a voltage equal magnitude during operation.

14. The method of claim 9, wherein a midpoint current from the midpoint of the two or more DC capacitors are equal.

15. The method of claim 9, further filtering each phase of the first 3-phase system and the second 3-phase system.

16. The method of claim 9, further comprising controlling a charging cycle and discharge cycle of the two or more DC capacitors.
